(19) United States
(12) Patent Application Publication
(10) Pub. No.: US 2026/0070852 A1
(43) Pub. Date: Mar. 12, 2026

(54) Hands-Free Waste Food Processing Machine

(71) Applicant: Iain Milnes, Fremont, CA (US)

(72) Inventor: Iain Milnes, Fremont, CA (US)

(21) Appl. No.: 18/882,460

(22) Filed: Sep. 11, 2024

(51) Int. Cl. C05F 9/02; B09B 3/40; B09B 3/60; B09B 101/70; C05F 9/04; C05F 17/907; C05F 17/971; E05F 15/50; E05F 15/603

(52) U.S. Cl. CPC C05F 9/02; B09B 3/40; B09B 3/60; C05F 9/04; C05F 17/907; C05F 17/971; E05F 15/50; E05F 15/603; B09B 2101/70; E05Y 2400/30; E05Y 2400/858; E05Y 2900/00

(57) ABSTRACT

A waste food processing machine provides hands-free operation for improved hygiene and convenience, particularly where minimizing contact with surfaces is essential. The machine incorporates a control system coupled with a door opening mechanism and features a hands-free switch—such as a foot-operated or bump switch—that allows users to open and close the machine door without using their hands. The hands-free switch, mounted on the machine's chassis, sends activation signals to the control system to engage the door opening mechanism, which could be an electric motor or a hydraulic pump. This mechanism enables the access door to the drum to open or close. Should the switch be activated while the door is in motion, the door halts and can reverse its movement with subsequent activations.

### BACKGROUND

The present invention relates to a waste food machine that can be loaded with waste food without needing to touch the waste food machine.

A waste food machine disposes of waste food or reduces its volume and weight; such machines have been in use for about 25 years. Waste food machines may vary in size, with typical institutional machines processing from 20 kg per day to 3000 kg per day. Such devices may vary from about 50 cm wide to 400 cm wide. Many such machines are constructed mostly of stainless steel.

The waste food machine is a machine that is usually installed in an institutional kitchen. It is used by an organization or business that produces large quantities of waste food. The machines save or reduce the mess, cost, and inconvenience of sending the waste food to a landfill. When waste food is sent to a landfill it generally decomposes to methane (CH4) which is released to the atmosphere. CH4 is 84 times worse for the atmosphere than carbon dioxide. Businesses that generate waste food are realizing the implications of their waste food on the environment and the use of a waste food machine can help to significantly reduce their carbon footprint.

When an operator wants to put the waste food into the machine, he or she needs to firstly open the door of the machine. The majority of waste food machines have doors that are opened manually. Some machines may have doors that open by an electric motor or by a hydraulic piston. In the cases which are not manual, the operator has to scan a card or press a button. If the operator is using two hands to carry the waste food to the waste food machine, any of the current methods to open the door is inconvenient as the user has to put the waste down or otherwise free up his or her hand to open the door.

In today's fast-paced world, efficiency and hygiene in food processing and waste management have become paramount. Historically, the handling of waste food in commercial and residential settings has required direct human interaction, posing potential hygiene risks and decreasing productivity due to the manual nature of the task.

### SUMMARY OF THE INVENTION

In one aspect, the method involves equipping a waste food machine with a housing and an enclosed drum and features a hands-free switch that sends an activation signal, triggering a door opening mechanism to open the machine's door for hands-free operation.

In yet another aspect, a waste food processing machine supports hands-free operation. This machine features a housing that encompasses at least one drum intended for processing waste food and is equipped with at least one door for entry to the drum. A mechanism is provided for opening the door, and a hands-free switch is included. The machine's control system is designed to initiate the door opening mechanism upon receiving a signal from the hands-free switch.

In a further aspect, a waste food processing machine provides hands-free operation for improved hygiene and convenience, particularly where minimizing contact with surfaces is essential. The machine incorporates a control system coupled with a door opening mechanism and features a hands-free switch—such as a foot-operated or bump switch—that allows users to open and close the machine door without using their hands. The hands-free switch, mounted on the machine's chassis, sends activation signals to the control system to engage the door opening mechanism, which could be an electric motor or a hydraulic pump. This mechanism enables the access door to the drum to open or close. Should the switch be activated while the door is in motion, the door halts and can reverse its movement with subsequent activations.

The operator activates the opening of the door in one of two ways: 1) a foot switch is connected to the electrical system and the pressing of this switch causes the door to open; and 2) a bump switch is located on the chassis of the waste food machine and is pressed by the operator's knee, hip, or elbow, for example.

With either of these methods, the operator can continue to use both hands to carry and deposit the waste food into the machine. The foot switch can work in two different ways. The bump switch can operate only in the first of these ways. The first method is that a single press of the foot switch or bump switch will cause the door to open. The door opens fully, the operator deposits the waste food, and the operator presses the foot switch or bump switch again. The door closes.

In this method, if the operator presses the foot switch or bump switch while the door is moving, the door will stop moving. This allows the operator to stop the door if the operator identifies an obstruction. A further press of the foot switch or bump switch will cause the door to move again. For safety, it is better that the door reverses the direction in which it was previously moving, but it is possible to continue to move the door in the direction that it was moving prior to being stopped.

The second method is that the operator must press and hold the foot switch to open the door. The mechanism can then behave in one of two ways. If the operator takes his or her foot off the foot switch, the door can stop moving; alternatively, the door can go in the opposite direction. The latter way is less safe and less intuitive for the operator. With the first way, the operator can release the foot switch once the door is open, deposit the waste, and then press and hold the foot switch until the door is closed.

The system offers numerous advantages over traditional waste food management methods, providing an innovative solution that emphasizes hygiene, efficiency, and user experience. Some of the notable advantages of one implementation may include, but are not limited to, the following:

Enhanced Hygiene: By eliminating the need for direct contact with the waste food machine, the risk of contamination and spread of germs is significantly reduced. This is particularly important in commercial settings like restaurants, hospitals, and schools, where maintaining a high level of sanitation is paramount.

Improved Efficiency: Hands-free operation streamlines the process of waste disposal, enabling users to dispose of waste food rapidly and continue with other tasks without interruption. This can lead to increased productivity in commercial kitchens and households.

Safety: Reducing the need for physical interaction with the machine minimizes the risk of injury related to the manual opening and closing of the machine's door. This can help prevent accidents and ensure a safer environment for users.

User Convenience: The hands-free switch enables ease of use, offering convenience to users who may have their hands full or are otherwise unable to operate a manual switch. This design consideration makes it particularly user-friendly in busy or demanding settings.

Better Waste Management: Automation of waste food processing can lead to more consistent and effective waste management practices. By ensuring that waste is disposed of in an efficient and hygienic manner, the machine aids in maintaining a cleaner and more organized work setting.

Energy Efficiency: The system's automation may lead to optimized energy use since the machine can operate only when needed, reducing unnecessary power consumption when not actively processing waste.

Adaptive Integration: The design of the machine, which features a self-contained drum and housing, allows for easy integration into a variety of settings, including both residential and commercial environments, without significant modifications.

Robust Design: The integration of automated systems likely reflects a robust design that can withstand the wear and tear of frequent use while ensuring longevity and reliable operation.

Environmentally Conscious: By potentially improving the process of food waste disposal and processing, the machine might contribute to better recycling practices and the reduction of food waste in landfills, aligning with environmental sustainability goals.

Customizable Operation: A control system that reacts to signals from a hands-free switch can possibly be programmed with various settings to handle different types and amounts of food waste, accommodating the specific needs of the user.

The system offers a smart, practical, and sustainable solution for managing waste food and enhances the overall waste management system through its innovative, hands-free approach.

### BRIEF DESCRIPTION OF DRAWINGS

FIG. 1 shows an exemplary diagram of a waste food processing machine.

FIG. 2 shows the system of FIG. 1 with hands-free door opening and closing.

FIG. 3 shows an exemplary flowchart describing the operation of a hands-free operated waste food processing machine with a hands-free door mechanism.

### DETAILED DESCRIPTION OF THE INVENTION

The present system allows for the loading of waste food into a waste food machine without the need for manual door operation. The inventive concepts herein are applicable to two types of waste food machine: a wet type and a dry type. With the wet type of machine, waste food is put into the machine where it is decomposed in an aerobic manner and the output is sent as grey water down the drain. With the dry type of machine, waste food is dehydrated, reducing the volume significantly. The output can be sent to a landfill, sent for further processing to make compost, or used as a soil amendment.

Waste food processing machines feature a drum where the waste food is mixed and processed. A motor drives a shaft connected to mixing arms inside the drum, which thoroughly mixes the waste. Waste is introduced into the drum through a door, which is opened automatically (but can be manually opened as well). An inlet allows for the introduction of water and other substances necessary for processing. The machine is supported by either fixed supports or wheels to facilitate movement. The entire assembly is often enclosed in an outer casing typically made of stainless steel to ensure durability and ease of cleaning.

The system incorporates either a foot switch or a bump switch to facilitate hands-free operation. The foot switch, located on the floor, and the bump switch, positioned on the machine's chassis at a convenient height, are both connected to the door mechanism. Activation of these switches causes the door to open, allowing the operator to deposit the waste food without putting it down or using their hands. The switches can be connected to the control system via wires or wirelessly. This system improves the efficiency and hygiene of loading waste food into the machine, especially in settings where large quantities of waste are processed.

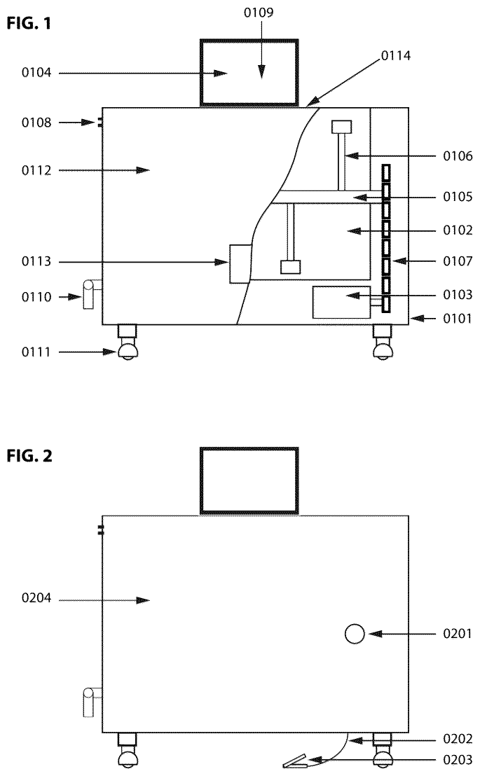

For a wet type of machine and referring to FIG. 1, a chassis 0101 supports a drum 0102 and a motor 0103. In general, waste food is put into drum 0102 through a door 0104. Motor 0103 drives a shaft 0105 with arms 0106 through a chain, belt, or system of gears 0107. Motor 0103 causes arms 0106 to rotate slowly (for example at about one revolution every five to 12 seconds) to mix old waste food with new waste food. Water may be added through an inlet 0108 to maintain the correct moisture content in drum 0102 for the decomposition process. The decomposition of the waste food may be accelerated by the addition of microorganisms, enzymes, or a blend of microorganisms and enzymes 0109 that are added periodically to drum 0102 either automatically or manually through door 0104.

In a typical machine, digested material exits the drum 0102 through a drain pipe 0110 and thereby the digested liquid and tiny particles may flow out of the machine to a drain. Chassis 0101 is often supported on supports 0111, of which there are typically four. In some machines, these supports may be combined with wheels to allow the machine to be moveable or the wheels may be separate. The supports may be the feet of load cells that allow the machine to weigh the waste food. An outer casing 0112 is usually made of stainless steel.

With a wet type of machine, the aerobic process of digestion when operating properly will not create CH4 and typically has no bad odors.

For a dry type of machine, the structure is similar to the wet type. However, water and microorganisms are not typically added to the machine. Usually, the machine is loaded with waste food, the door is closed, and the machine heats the waste food. Typically, the temperature is raised to 90° C. for six to 10 hours and a cycle takes about 18 hours. The machine may churn the waste during this process with the objective of breaking it into small pieces. At the end of the cycle, the dehydrated waste is emptied through an output door 0113, which is typically not present on the wet type of machine. The dehydrated waste is typically 5% to 10% of the original volume of waste food.

A hybrid type machine may start with a decomposition process similar to a wet type of machine, and, after a certain time, for example, 12 hours, the machine may then dry the remainder of the waste food similar to a dry type of machine.

The system allows the operator to open the door without using his or her hands. The door is operated either by an electric motor or by a hydraulic pump which itself is operated by an electric motor.

The operator activates the opening of the door in one of two ways:

A foot switch is connected to the electrical system and the pressing of this switch causes the door to open.

A bump switch is located on the chassis of the waste food machine and is pressed by the operator's knee, hip, or elbow, for example.

With either of these methods, the operator can continue to use both hands to carry and deposit the waste food into the machine.

The foot switch can work in two different ways. The bump switch can operate only in the first of these ways.

The first method is that a single press of the foot switch or bump switch will cause the door to open. The door opens fully, the operator deposits the waste food, and the operator presses the foot switch or bump switch again. The door closes.

In this method, if the operator presses the foot switch or bump switch while the door is moving, the door will stop moving. This allows the operator to stop the door if the operator identifies an obstruction. A further press of the foot switch or bump switch will cause the door to move again. For safety, it is better that the door reverses the direction in which it was previously moving, but it is possible to continue to move the door in the direction that it was moving prior to being stopped.

FIG. 2 illustrates an exemplary hands-free operated waste food processing machine with a controlled door mechanism. The process includes providing a waste food machine with a housing, a drum enclosed within the housing, and at least one door. Following this, an activation signal is received from a hands-free switch, which activates the door opening mechanism in response. Finally, the door of the waste food machine is opened.

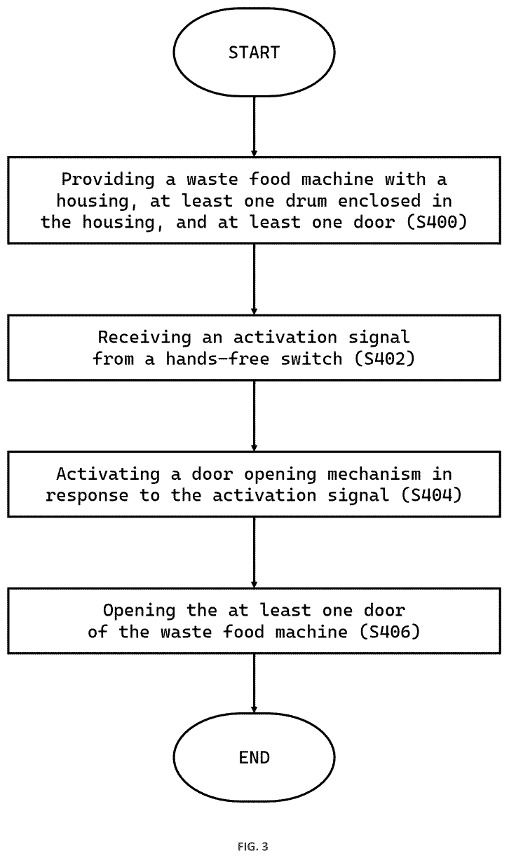

FIG. 3 illustrates the operation of the hands-free door system:

Providing a waste food machine with a housing, at least one drum enclosed in the housing, and at least one door (S400).

Receiving an activation signal from a hands-free switch (S402).

Activating a door opening mechanism in response to the activation signal (S404).

Opening the at least one door of the waste food machine (S406).

Reviewing FIG. 2 and FIG. 3 in combination, the hands-free operation is detailed. In FIG. 2, the chassis 0204 corresponds to 0112 in FIG. 1. The door 0205 is that introduced in FIG. 1 as 0104. A switch 0201 is mounted on the chassis at a height convenient to be activated by a person's hip, elbow, or other part of the body. The switch 0201 is connected to the control system by wires or wirelessly to the control system. The operator will press this switch to open or close the door 0205. Usually, a machine will have either switch 0201 or switch 0203 installed. However, some applications may have both switches installed.

The system allows the door to be opened without using hands by introducing two types of switches: a foot switch and a bump switch. These systems are designed to make the operation of waste food machines more convenient and efficient by reducing the need for manual door handling.

This implementation provides a hands-free door opening mechanism that can be activated using a foot switch or a body-activated bump switch. The foot switch is pressed by foot to open the door while the bump switch is activated by body parts such as the hip or elbow. This allows the operator to keep holding the waste food while opening the door.

The machine can use one or both switches, connected either via wire or wirelessly through technologies like Bluetooth or Zigbee.

Single press method: Opens and closes door fully with presses. This method involves a simple operations mechanism activated by a single press to open the door fully. Once the waste is deposited, another single press closes the door. Pressing the switch mid-operation will halt door movement for obstruction detection. A further press moves the door in reverse or continues its prior direction.

Press and hold method: Operator holds switch to open door, release stops door. In this case, the bump switch requires continuous pressure to keep the door open. The door starts to open when the operator presses the bump switch and remains open as long as the switch is held. Once the operator releases the bump switch, the door movement stops. To close the door, the operator must press and hold the bump switch again. While this method provides immediate control over the door's movement, it is less intuitive and potentially less safe compared to the first method.

The bump switch design ensures ease of use by allowing quick and efficient operation, making it particularly advantageous in environments where the operator frequently has their hands full. Additionally, the hands-free operation enhances hygiene by minimizing direct contact with the waste food machine, thereby reducing the likelihood of contamination. This innovation is especially beneficial in institutional kitchens, food processing plants, and other settings where managing large volumes of waste food is common. The incorporation of the bump switch into the waste food machine represents a significant improvement in operational efficiency and user convenience.

Once the waste food has been deposited into the machine, the hands-free switch can be activated again to close the door. The operator sends a second activation signal to the control system by pressing the hands-free switch for a second time. In response to the second activation signal, the control system actuates the door-closing mechanism, typically powered by the same electric motor or hydraulic pump used for opening the door, to safely and securely close the door.

The control system is also designed to enhance safety by providing a mechanism to stop the door's motion if an obstruction is detected. If the operator presses the hands-free switch while the door is moving, the door will halt its movement, allowing the operator to resolve the obstruction. Further pressing of the hands-free switch will resume the door's movement, either continuing in the same direction or reversing, depending on the specific implementation.

The invention further includes a feature wherein the control system is configured to reverse the direction of the door movement upon receiving a subsequent activation signal from the hands-free switch. This feature enhances the safety and convenience of the waste food machine operation. For instance, if an operator initially activates the door opening using either the foot switch or the bump switch, the door will start to open. Should the operator identify an obstruction or a need to halt the door progression midway, a subsequent press of the same switch will immediately trigger the control system to reverse the direction of the door's movement.

Upon receiving this subsequent activation signal, the door, which was previously opening, will promptly start closing, and vice versa, depending on its prior state. This ensures that if any unforeseen circumstances arise during the door's operation, such as an obstruction in the pathway or other operational issues, the operator can quickly intervene and alter the door's direction without needing to use their hands or engage with any complicated controls.

When the hands-free switch is activated, the system continuously opens the door. This operation is achieved by maintaining an electrical connection within the control system that keeps the door motor or hydraulic pump running. As soon as the hands-free switch, such as a foot-operated switch or a bump switch, is engaged, it sends a signal to the control mechanism, initiating the movement of the door. The door continues to open smoothly, driven by the connected motor or hydraulic system, until the switch is deactivated.

The hands-free switch, whether it is pressed by an operator's foot or another part of the body like the hip or elbow, remains engaged, and the door keeps moving towards the fully open position. This continuous motion ensures that the operator does not have to use their hands to manage the door, thereby allowing them to carry waste food or other items with both hands without interruption.

This detailed description covers how the activation and deactivation of the hands-free switch controls the door movement in a waste food machine, providing a hands-free operational advantage to the user.

The door opening mechanism can be an electric motor. The electric motor provides the necessary force to open and close the door automatically. This mechanism eliminates the need for manual operation, thus allowing the operator to keep both hands free. The motor is connected to the door via a system of gears or a chain that translates the rotational motion of the motor into the linear motion required to open and close the door. When an operator activates the switch, an electrical signal is sent to the motor, causing it to start rotating. This rotation moves the door along its track, opening it fully. Upon receiving a subsequent signal from the switch, the motor reverses its rotation, causing the door to close. The motor's operation can be powered by an external electrical source and is typically governed by a control unit that manages the direction and duration of the motor's rotation. The control unit may include safety features such as sensors to detect obstructions in the door's path. If an obstruction is detected, the control unit can stop the motor or reverse its direction to prevent injury or damage. The electric motor used in the door opening mechanism is preferably a high-torque motor to ensure reliable operation even under load. The motor is housed in a protective casing to prevent exposure to environmental factors such as moisture and dust. The entire system can be integrated with various types of sensors and switches, including foot switches and bump switches, to facilitate hands-free operation. The motor and control unit are designed to require minimal maintenance, contributing to the overall reliability and longevity of the waste food machine. The use of an electric motor not only enhances the convenience of operating the machine but also ensures that the door operates smoothly and efficiently. This automated operation is particularly beneficial in institutional settings where operators frequently need to dispose of large quantities of waste food and need to maintain hygiene standards by not touching the machine with their hands. The electric motor can also be connected to a remote control system, allowing operators to open or close the door from a distance, further improving the ease of use.

In the second mode, the operator must maintain continuous pressure on the foot switch to keep the door open. Releasing the switch will stop the door's movement immediately, providing a direct and responsive control method. This mode ensures that the door only operates while the switch is actively engaged by the operator.

The control system can incorporate either a wired or wireless connection between the switches and the door mechanism. Wireless configurations may use communication standards such as Bluetooth or Zigbee, offering flexibility in the machine's installation and operation. The machine may be equipped with one or both types of hands-free switches, catering to various user preferences and operational requirements.

Overall, the hands-free control system enhances the functionality and user-friendliness of waste food machines, making them more suitable for environments where hygiene and efficiency are paramount. This system allows operators to manage waste food without direct contact with the machine, reducing the contamination risk and streamlining the waste disposal process.

The control system is an integral part of the waste food processing machine, as it manages the activation signals from the hands-free switch to the door opening mechanism. This system can be configured to work with wired or wireless connections, including advanced connectivity options such as Bluetooth or Zigbee, enhancing the adaptability and convenience of the machine. The control system ensures that each signal from the hands-free switch is accurately and promptly processed to operate the door opening mechanism, thus providing a seamless hands-free operation.

In sum, the described waste food processing machine offers a robust and user-friendly solution for handling waste food with an innovative hands-free operation capability, ensuring efficiency, hygiene, and safety in waste food management.

The foregoing description has been offered for purposes of exemplification of the instant invention and many of the specific operations can be performed by common alternative equipment readily available and well-known to the skilled engineer. Accordingly, many of these variations and alternatives may be adopted without departing from the scope of this invention as claimed hereinafter.

1. A method for hands-free operation of a waste food machine, comprising:
providing a waste food machine with a housing, at least one drum enclosed in the housing, and at least one door;
receiving an activation signal from a hands-free switch;
activating a door opening mechanism in response to the activation signal; and
opening the at least one door of the waste food machine.

2. The method of claim 1, wherein the hands-free switch is a foot switch.

3. The method of claim 1, wherein the hands-free switch is a bump switch located on the chassis of the waste food machine.

4. The method of claim 1, further comprising:
receiving a second activation signal from the hands-free switch;
closing the at least one door of the waste food machine in response to the second activation signal.

5. The method of claim 1, further comprising:
stopping the movement of the door if the hands-free switch is activated while the door is in motion.

6. The method of claim 5, further comprising:
reversing the direction of the door movement upon receiving a subsequent activation signal from the hands-free switch.

7. The waste food machine of claim 5, wherein the control system is further configured to reverse the direction of the door movement upon receiving a subsequent activation signal from the hands-free switch.

8. The method of claim 1, wherein opening the at least one door, comprises:
continuously opening the door while the hands-free switch is activated;
stopping the door movement when the hands-free switch is deactivated.

9. The method of claim 8, further comprising:
closing the door when the hands-free switch is reactivated and held.

10. The waste food machine of claim 8, wherein the control system is further configured to close the door when the hands-free switch is reactivated and held.

11. The method of claim 1, wherein the door opening mechanism is driven by an electric motor.

12. The method of claim 1, wherein the door opening mechanism is driven by a hydraulic pump.

13. The waste food machine of claim 1, wherein the hands-free switch is a foot switch connected to the control system.

14. The waste food machine of claim 1, wherein the hands-free switch is a bump switch mounted on the chassis of the waste food machine.

15. The waste food machine of claim 1, wherein the hands-free switch is a bump switch mounted on a wall or pillar near to the chassis of the waste food machine.

16. The waste food machine of claim 1, wherein the control system is further, configured to close the at least one door in response to a second activation signal from the hands-free switch.

17. The waste food machine of claim 1, wherein the control system is further, configured to stop the movement of the door if the hands-free switch is activated while the door is in motion.

18. The waste food machine of claim 1, wherein the control system is configured to, comprising:
continuously open the door while the hands-free switch is activated;
stop the door movement when the hands-free switch is deactivated.

19. The waste food machine of claim 1, wherein the door opening mechanism, comprises an electric motor.

20. The waste food machine of claim 1, wherein the door opening mechanism, comprises a hydraulic piston driven by a hydraulic pump that itself is operated by an electric motor.

21. A waste food processing machine with hands-free operation capability, comprising:
a housing;
at least one drum enclosed in the housing for processing waste food;
at least one door for accessing the at least one drum;
a door opening mechanism;
a hands-free switch; and
a control system configured to activate the door opening mechanism in response to an activation signal from the hands-free switch.
